(19) United States
(12) Patent Application Publication
(10) Pub. No.: US 2006/0219941 A1
(43) Pub. Date: Oct. 5, 2006

(54) BUBBLE TYPE RADIATION DETECTORS HAVING AUTOMATED READ-OUT

(76) Inventors: Edward Thomas Clifford, Deep River, Ontario (CA); Kenneth Roy Garrow, Chalk River, Ontario (CA); Sabeshan Kanagalingam, Deep River, Ontario (CA); Liqian Li, Deep River, Ontario (CA)

Correspondence Address: IAN FINCHAM, SUITE 606, 225 METCALFE STREET, OTTAWA, ON, K2P 1P9, CA

(21) Appl. No.: 11/308,483

(22) Filed: Mar. 29, 2006

Related U.S. Application Data
(60) Provisional application No. 60/665,844, filed on Mar. 29, 2005.

(51) Int. Cl. G01N 21/00; G01N 5/00

(52) U.S. Cl. 250/474.1

(57) ABSTRACT

A method and apparatus for automated read-out of a superheated droplet-to-bubble type detector whereby a light source is positioned near one end of a droplet-containing medium which is protected from undesired light. A light sensor is positioned to detect changes in light that has traversed the medium from the light source. The sensor provides a read-out signal of changes in light intensity due to radiation and the read-out signal is monitored. Optionally, the light source intensity is monitored to correct the read-out signal for fluctuations in the light source intensity.

### FIELD OF THE INVENTION

This application describes a method and apparatus for continuous readout of the superheated-droplet “bubble-type radiation detector” (BD) as described in U.S. Pat. Nos. 4,613,758 and 5,105,088. These detectors are sensitive to fast and/or thermal neutrons and signal the presence of neutrons through the formation of visible bubbles in the gel medium, the number of which are proportional to the number of neutrons incident on the detector.

In the conventional application of bubble detectors for neutron radiation dosimetry the number of bubbles is counted by eye or in an automatic reader by image analysis. In anti-terrorism or other security applications involving the detection and interdiction of neutron-emitting materials, it is desirable to detect the presence of neutron-induced bubbles in real time as they form, in order to react in a timely fashion to the situation underlying the neutron emission.

### STATEMENTS OF INVENTION

The invention includes a method for automated read-out of a radiation detector of the superheated droplet-to-bubble type, comprising:

a) positioning a selected light source in proximity to one end of the droplet-containing medium so that light from the source will traverse the medium;

b) protecting the medium from undesired light;

c) positioning a selected light sensor so as to detect only changes in light that has traversed the medium from the source, the sensor being selected to provide a read-out signal of changes in light intensity due to radiation; and

d) passing the read-out signal to appropriate monitoring means.

Desirably, the light source intensity is monitored to correct the read-out signal for fluctuations in the light source intensity.

Further, it is desirable that the detection sensitivity of the light sensor is improved by measuring the intensity of the light source with a second light sensor to reduce the effects of the fluctuations of the light source.

Preferably, transient decreases or increases in light intensity are sensed and counted to give a real time count of bubbles as they form.

Further, it is preferable that low power components are selected to give a small battery-operated or equivalent system.

The present invention also provides for an automated radiation detector of the superheated droplet-to-bubble type, comprising:
i) detector means including a selected medium having dispersed droplets adapted to be superheated when in use;
ii) a selected light source in proximity to one end of the medium and adapted to pass light through the medium;
iii) means to protect the medium from undesired light; and
iv) a selected light sensor positioned to detect changes in light passing through the medium from the light source, the sensor being selected to provide a read-out signal of the changes in light passing through the medium.

Desirably, the light source is a light emitting diode, the light sensor is an integrated photodiode/preamplifier chip or a photodiode, the monitor includes a counter, a display and a communication interface and all components are selected to be small battery powered or the equivalent.

Preferably, the detector also comprises a second light sensor positioned to measure the intensity of the light source.

Further, it is preferable that the second light sensor is an integrated photodiode/preamplifier chip or a photodiode.

### BRIEF DESCRIPTION OF THE DRAWINGS

Having thus generally described the present invention reference will now be made to the accompanying drawings.

FIG. 1 illustrates the automated radiation detector of the present invention.

### DETAILED DESCRIPTION OF THE DRAWINGS

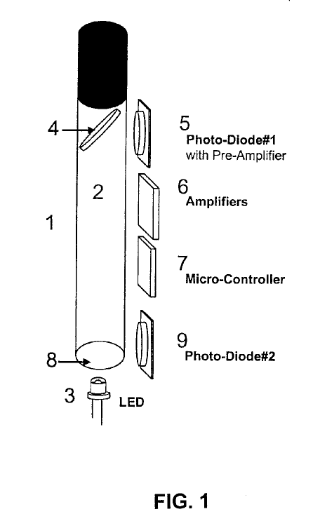

The modified detector (as in e.g. FIG. 1) is housed in an appropriately shielded (not shown) transparent vessel (or opaque except for selected portions), typically cylindrical, that is illuminated by a light source placed at one end. In this embodiment the BD is viewed by one photodiode positioned on the side of the cylinder near the other end. Optionally, a second photodiode near the light source views the light source to measure its intensity fluctuations.

Bubble formation preferably is detected by transient steps in the observed light signal. Transient or differential detection, i.e. the detection of the formation of each bubble, is preferred over integral detection, which involves the gradual change in the scattered light level over time as bubbles accumulate. This preference for the differential over the integral approach arises because the latter is sensitive to bubble size, bubble positions within the detector, fluctuations in the output intensity of the light source and tiny DC level drifts in the circuitry.

FIG. 1 is a schematic view of one embodiment illustrating the invention. In this example, FIG. 1, the automated detector is shown overall at 1 in tubular form and having droplet-containing medium at 2. A light source 3 (e.g. LED) is adapted to direct light through light-transmitting closure 8 to traverse medium 2 and reach reflecting means 4. The light source is typically infrared to visible, not UV or ultrasound. Preferably, infrared to red is used to match detector sensitivity curve. Means 4 is angled to reflect light from 3 through the sidewall or transparent port therein to sensor 5 (e.g. photodiode #1). Optionally, a second sensor 9 (e.g. photodiode #2) may be positioned near the light source 3 to measure its intensity fluctuations. A light-protective sheath or sleeve (not shown) should surround 1 (with openings for 3, 5 and 9 to function) when the walls of 1 are transparent. Alternatively the walls or containment could be opaque (except at 8, 9 and 4 to 5). By selecting low power components, the embodiment of FIG. 1 can operate with low power consumption (for example, drawing less than 3 mA in total).

Appropriate signal amplification is provided at 5 and 6 and the amplified signal passed to monitor 7 (e.g. micro-controller plus display).

The present embodiment has been developed to instrument preferably the “Defender”™ BD, which is a special high sensitivity, (˜100 to 1000 times that of the standard detector) detector for security applications. The read-out preferably comprises a red LED illuminating the bottom of the detector, an integrated photodiode/preamplifier chip or a photodiode viewing the interior of the BD from the side, and pulse counting electronics. Depending on the particular use, it could have a display and/or a standard communication interface to couple to a communication device such as a cell phone or a computer. Wireless communication systems could be used. Again, depending on the application, additional capability such as GPS and time stamping could be resident in the reader; alternately these could be located in cell phone or other communication system. The FIG. 1 embodiment uses optical reflection to optimize the signal/noise ratio (SNR) of the bubble-formation transients.

In the geometry illustrated the system is detecting a decrease in light intensity due to the formation of macroscopic bubbles in the light path. The system is also detecting an increase in light intensity when bubbles form near the light detector. The preferred transient method of detection senses the instantaneous change in light intensity when a bubble forms. (Single bubbles can be sensed.) This intensity change appears as a transient in the signal on the sensor output; this transient is detected and counted in a register. This is done digitally by encoding the photosensor-assembly output and using digital filter techniques to detect the transient. Thus an actual count of bubbles as they form is obtained and, as a byproduct, an integral measurement that gives a cruder estimate to the total bubble count subject to the caveats mentioned including sensitivity to bubble size and position, and sensitivity to DC drifts in the operating point of the system. The integral data would be important in the event of exposure to an intense source resulting in a large number of bubbles in a short time.

It would also be possible, as a cost-saving measure, to use an analogue electronic filter to detect the bubble formation and to scale the events. In this case digital encoding is not required and no integral information would be garnered.

A number of options exist for illumination including LED's of various colours, compact incandescent or fluorescent lamps, and lasers. A number of photodetectors are possible including photomultiplier tubes (PMTs), silicon or other semiconductor photodiodes, avalanche photodiodes, and solar cells. Standard interfaces including RS232 and USB can be used and power for the device can be supplied by batteries, through the communication interface or from an external supply.

What is claimed is:

1. A method for automated read-out of a radiation detector of the superheated droplet-to-bubble type, comprising:
a) positioning a selected light source in proximity to one end of the droplet-containing medium so that light from the source will traverse the medium;
b) protecting the medium from undesired light;
c) positioning a selected light sensor so as to detect only changes in light that have traversed the medium from said source, the sensor being selected to provide a read-out signal of changes in light intensity due to radiation; and
d) passing said read-out signal to appropriate monitoring means.

2. The method of claim 1, further comprising the step of monitoring the light source intensity to correct the read-out signal for fluctuations in the light source intensity.

3. The method of claim 1, wherein the detection sensitivity of the light sensor is improved by measuring the intensity of the light source with a second light sensor to reduce the effects of the fluctuations of the light source.

4. The method of claim 1, wherein transient decreases or increases in light intensity are sensed and counted to give a real time count of bubbles as they form.

5. The method of claim 1, wherein low power components are selected to give a small battery-operated or equivalent system.

6. An automated radiation detector of the superheated droplet-to-bubble type, comprising:
i) detector means including a selected medium having dispersed droplets adapted to be superheated when in use;
ii) a selected light source in proximity to one end of said medium and adapted to pass light through said medium;
iii) means to protect the medium from undesired light; and
iv) a selected light sensor positioned to detect changes in light passing through the medium from the light source, the sensor being selected to provide a read-out signal of said changes in light passing through the medium.

7. The detector of claim 6, wherein the light source is a light emitting diode, the light sensor is an integrated photodiode/preamplifier or a photodiode, the monitor includes a counter, a display and a communication interface and all components are selected to be small battery powered or the equivalent.

8. The detector of claim 7, wherein the light sensor is a photodiode.

9. The detector of claim 6, further comprising a second light sensor positioned to measure the intensity of the light source.

10. The detector of claim 9, wherein the second light sensor is an integrated photodiode/preamplifier chip or a photodiode.

11. The detector of claim 10, wherein the second light sensor is a photodiode.
